(19) United States
(12) Patent Application Publication
(10) Pub. No.: US 2013/0199040 A1
(43) Pub. Date: Aug. 8, 2013

(54) Device and method for treatment of high-pressure turbine blades of a gas turbine

(71) Applicant: Rolls-Royce Deutschland Ltd & Co KG, Blankenfelde-Mahlow (DE)

(72) Inventors: Matthias DUDECK, Berlin (DE); Juergen DUPRE, Zeesen (DE); Eckart UHLMANN, Kiebitzreihe (DE); Martin BILZ, Berlin (DE)

(73) Assignee: Rolls-Royce Deutschland Ltd & Co KG, Blankenfelde-Mahlow (DE)

(21) Appl. No.: 13/755,719

(22) Filed: Jan. 31, 2013

(30) Foreign Application Priority Data
Feb. 6, 2012 (DE) 10 2012 002 275.1

(51) Int. Cl. B23P 6/00

(52) U.S. Cl. CPC B23P 6/002
USPC 29/889.1; 29/700

(57) ABSTRACT

The present invention relates to a device and a method for in-situ treatment of turbine blades/vanes of a gas turbine, with the treatment device being insertable into a combustion chamber of the gas turbine via at least one access aperture and placeable on cooling-air recesses of the turbine blades, with the treatment device at its end including a tool head with at least one tool and at least one jet nozzle, with the jet nozzle being connected to a medium hose for externally supplying a treatment fluid, with the treatment device being provided with an actuating device for exactly guiding and/or placing and/or moving the tool head.

This invention relates to a device and a method for treatment of high-pressure turbine blades of a gas turbine in order to remove deposits and/or foreign matter coatings in the area of cooling-air recesses or cooling-air holes on the high-pressure turbine blades.

Stator vanes and rotor blades in the high-pressure turbine area feature film cooling of the surface for protection of component surfaces which are in contact with the hot gas flow. This cooling is generated by a varying number of cooling-air holes of the blade.

During operation of an engine, the cooling-air holes are partially or completely closed by various influences.

This leads to a restriction or to a partial loss of the film cooling for the stator vane and rotor blade surfaces, which can result in the destruction of the component. For these reasons, the cooling-air holes on the stator vanes and the rotor blades must be restored to their proper state in the course of repair measures.

To do so, the engine must, according to the state of the art, be removed from the aircraft and transferred to dedicated and authorized workshops. These workshops require a level of equipment almost comparable to that for new part production facilities. In addition, the aircraft must be equipped with a replacement engine for the duration of the engine repair work. The costs for these measures are considerable.

The object underlying the present invention is to provide a device and a method of the type specified at the beginning which are simple to implement and simple in design and which permit dependable clearing and/or treatment of the cooling-air holes on high-pressure turbine blades of a gas-turbine engine.

It is a particular object of the present invention to provide solution to the above problematics by a combination of the features of the independent Claims. Further advantageous embodiments of the present invention become apparent from the sub-claims.

In accordance with the invention, the method for clearing the cooling-air holes on high-pressure turbine blades is performed on a non-removed aircraft engine. It is thus not necessary in accordance with the invention to replace an engine in an aircraft or to transfer the engine to a workshop; instead the method in accordance with the invention is performed on the installed engine.

In accordance with the invention, in the non-removed state of the engine the device in accordance with the invention, i.e. a manual, semi-automated or automated controllable tool, is used to remove the deposits and/or foreign matter coatings only at those points at which they should be removed. The deposits and/or foreign matter coatings are cleaned off by blasting using a compressed fluid jet. The fluid used can be water and/or water with additives, oil, carbon dioxide or nitrogen. Furthermore, the use of high-energy light (laser) is suitable for removing the foreign matter coatings.

After cleaning off or removal of the deposits and/or foreign matter coatings, it is favourable in a development of the invention to conduct additional rinsing or cleaning of the high-pressure turbine blades, in particular also of the interiors of the high-pressure turbine blades, for example by means of a gas flow, for example air, to rinse out or expel where necessary any particles entering through the cooling-air recess.

In accordance with the invention, the method is preferably conducted under visual control, for example with the aid of an endoscope.

Furthermore, it is particularly favourable in accordance with the invention when the tools and/or equipment needed to perform the method are inserted into the area of the high-pressure turbine through boroscope apertures provided in the gas turbine or through burner apertures of the combustion chamber.

The guiding of the tool and/or equipment to the area to be treated is achieved in accordance with the invention by a device having the capability to change its shape individually due to the use of shape memory alloys. For treatment, the fuel injection nozzles of the combustion chamber for the respective sections are removed. An insert sleeve is inserted into the resulting aperture, through which sleeve the tool and/or device is introduced radially. The latter has a 90° angle and is screwed into the aperture of the removed fuel injection nozzles. The tool and/or device is pushed radially and axially through the insert aid and hence directly routed to the appropriate section. The device is controlled by shape memory wires which act as “artificial muscles” in that they contract after heating and thereby bend the device. After cooling, they relax again and resume their original shape. In the device, two wires are arranged offset by 90° on a hose, and positively braced at their start and end. The hose has a stiffness sufficient to apply a resetting force necessary to restore the wires to their original shape after cooling. The wires are pressed using a shrink-on hose directly onto the carrier hose and hence guided to achieve the maximum possible deformation. Thanks to the 90°-offset wires, the tool moves on a circular track. The wire can be positioned accordingly with a controlled heating of the resistor. The combustion chamber is divided into sections, so that the accessibility of all sections of the stator vanes for the tool is assured. By the tangential movement of the tool on a circular track, the cooling-air holes on the leading edge of the stator vanes in this section are reached and then treated. By changing the tool head it is possible to navigate optionally also between the individual stator vanes and to treat the cooling-air holes on the suction and pressure sides. In this way, the rotor blades located axially behind the stator vanes can also be reached and their cooling-air holes can likewise be treated using this method.

The guiding of the tool and/or equipment to the area to be treated can also be achieved in accordance with the invention by using rail systems to be inserted and which can be of rigid, flexible or also volume-increasing design. The rail systems are designed such that individual and prefabricated tube sections are successively inserted through the boroscope aperture or the aperture of the removed fuel injection nozzles. The tube sections should here ideally be rigidly connected to one another. The device is based on the fact that the appropriate area to be cleaned is approached depending on the preceding visual inspection. In the same way, prefabricated elastic devices can be inserted into the combustion chamber and inflated using compressed air. With these devices, the tool proper can then be guided to its intended destination.

It is furthermore possible to use cable pull systems for guidance and navigation of the tools and/or equipment inserted into the engine through various apertures. To do so, in accordance with the invention a device should be fastened above the boroscope aperture or an aperture of a removed fuel injection nozzle and/or the engine outlet, and a further device also fastened to the engine outlet for guidance of the cable system. The tool and ideally an optical unit is fastened to the cable system and is guided by the movement of the cable to the appropriate blade.

After the removal of engine attachments too, such as fuel injection nozzles, igniter plugs etc., the aforementioned apertures are obtained and can be used in accordance with the invention. The high-pressure turbine area is readily accessible through these apertures, without additional or extensive removal work being necessary. The method in accordance with the invention is thus distinguished by rapid and inexpensive performability. By restoring the function of the cooling-air holes on the engine while it is installed in the aircraft, any removal of the engine and any repair in specially authorized workshops, as well as installation of a leased or substitute engine in the aircraft, are avoided. The method in accordance with the invention thus results on the one hand in a considerable cost reduction and on the other hand in a considerable shortening of the down time of the aircraft.

The present invention is described in the following in light of the accompanying drawing, showing exemplary embodiments. In the drawing,

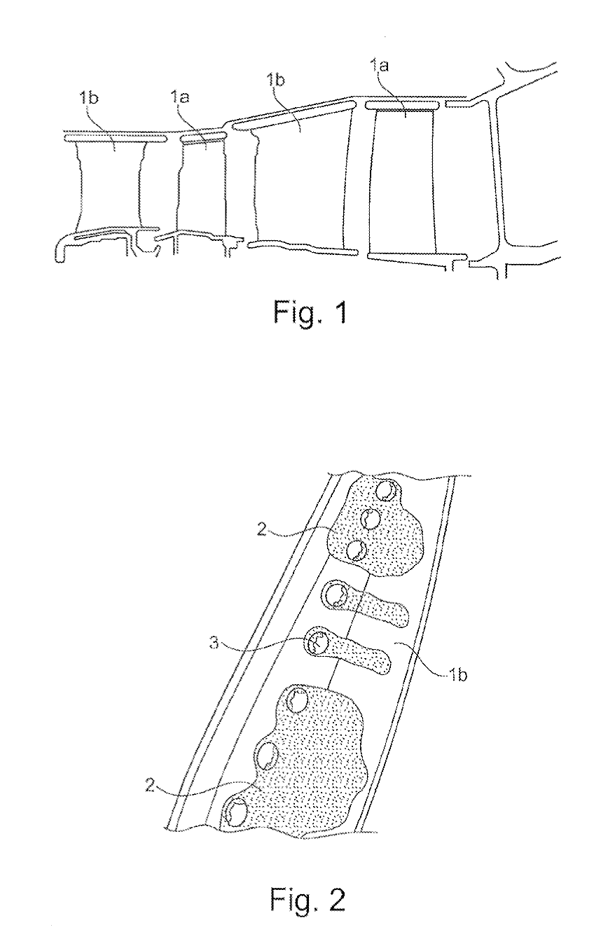

FIG. 1 shows a schematic sectional view of a high-pressure turbine in accordance with the invention having rotor blades and stator vanes,

FIG. 2 shows a perspective view of a stator vane in accordance with the invention with deposits and/or foreign matter coatings,

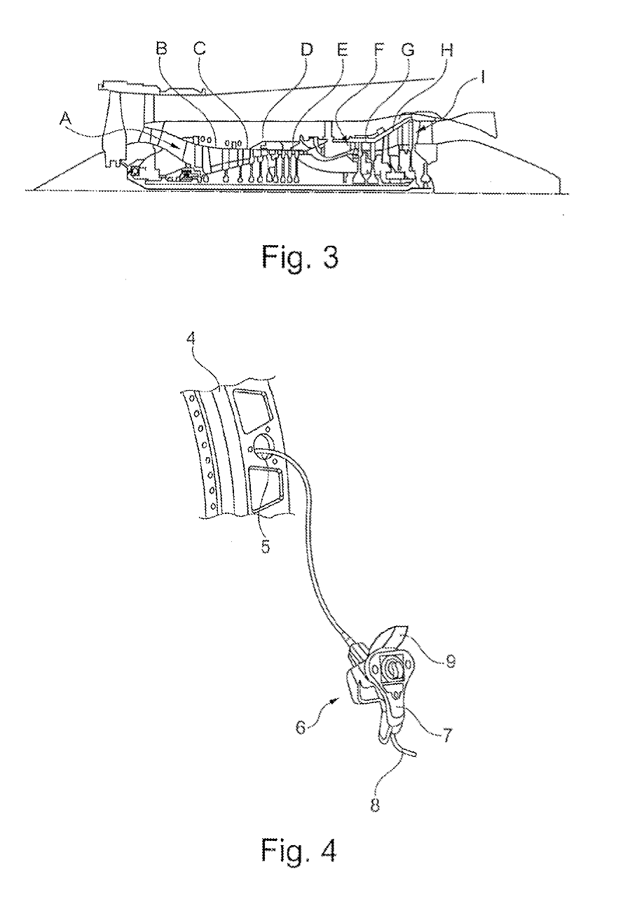

FIG. 3 shows a schematic representation of a gas-turbine engine with accessibilities for boroscope work,

FIG. 4 shows a simplified schematic representation of a boroscope equipment,

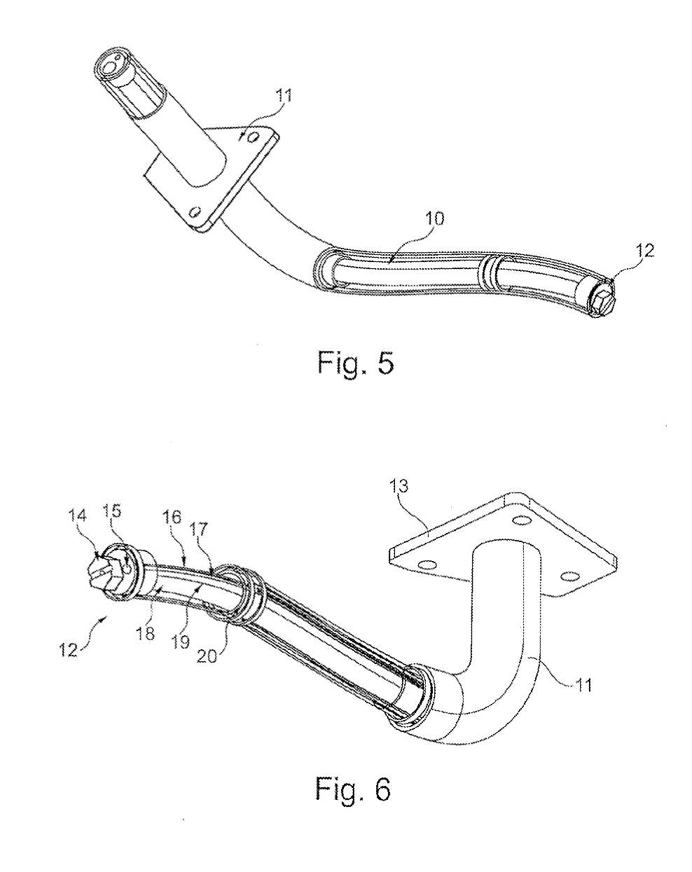

FIG. 5 shows a perspective view of an exemplary embodiment of the device in accordance with the invention with an insert aid,

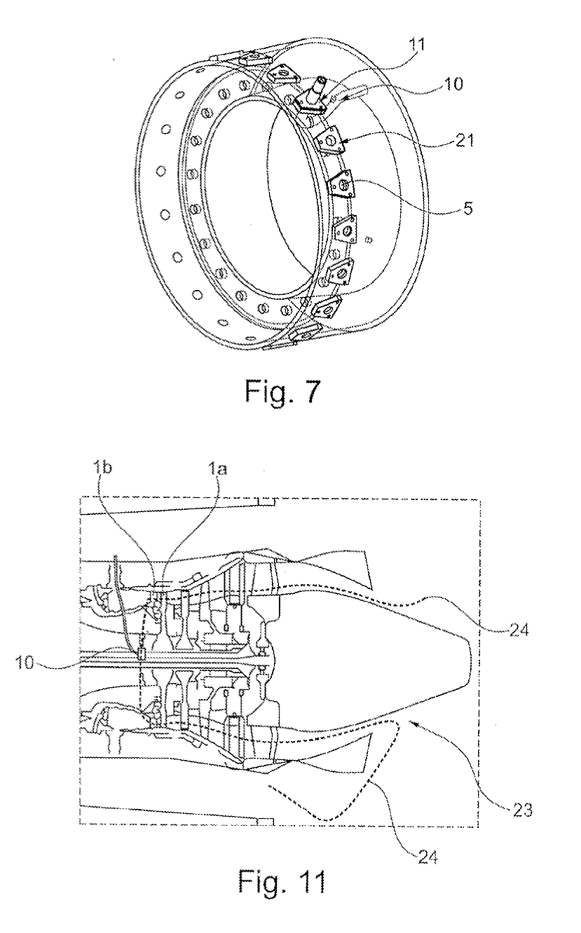

FIG. 6 shows a detail view of the device in accordance with FIG. 5,

FIG. 7 shows a simplified representation of a combustion chamber with the device inserted,

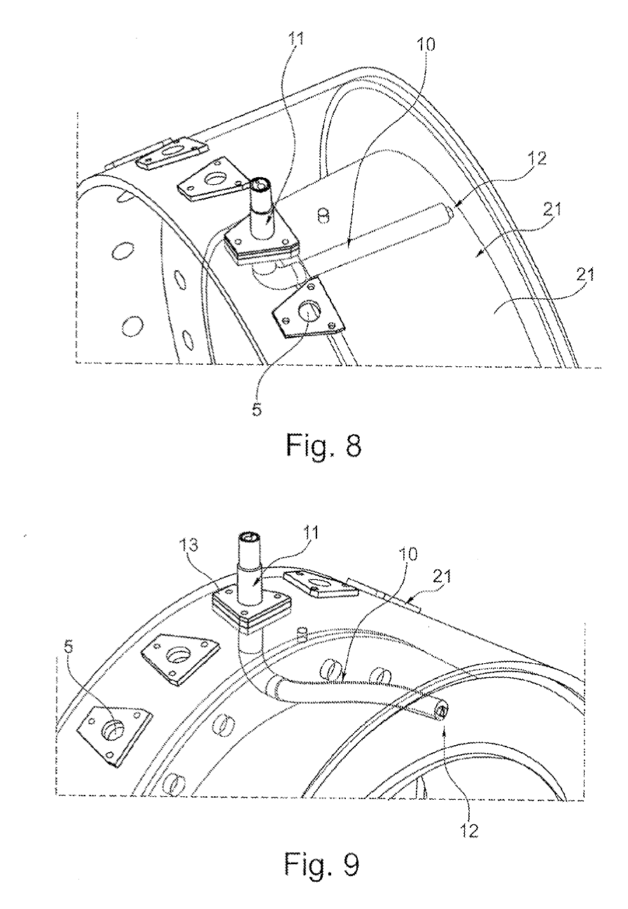

FIGS. 8, 9 show sketches of the device in accordance with the invention in the non-active (FIG. 8) and the active (FIG. 9) state of the combustion chamber,

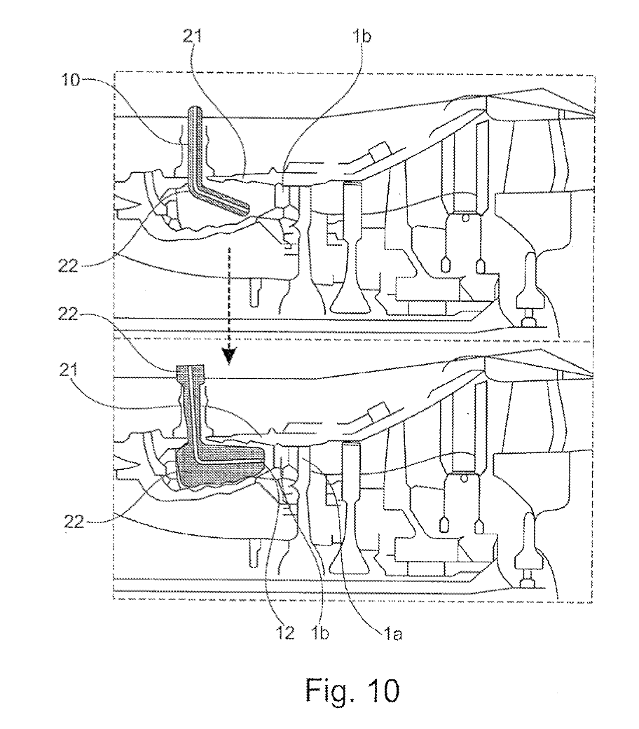

FIG. 10 shows a simplified sketch representing the use of inflatable rails for guiding of the tool, and

FIG. 11 shows a simplified sketch representing the use of cable pull systems for guiding of the tool.

FIG. 1 shows a simplified sectional view with rotor blades 1a of a high-pressure turbine of a gas-turbine engine and with stator vanes lb of the high-pressure turbine. The design corresponds to the state of the art, so that further explanations can be dispensed with.

FIG. 2 shows in a perspective and simplified view a partial area of a leading edge of a high-pressure turbine vane 1b, which is provided with cooling-air recesses 3 (cooling-air holes). FIG. 2 shows in the upper area deposits 2 caused by foreign matter in the gas flow, and in the lower area deposits 2 caused by the internal cooling air flowing out of the cooling-air recesses 3 during operation of the gas turbine, as well as deposits directly inside the hole which slowly clog the hole diameter.

To dispense with the need to remove engines, visual inspections are conducted using a boroscope or flexoscope. This thin tube, which originates in medical endoscopy, is equipped on the inside with an optical lens which can be inserted into a cavity to be tested. Optic fibers enclose the optical unit and supply the light from a connected source to the point of inspection, from where a reflected image passes through the optical unit back to the eye of the beholder or into a camera with connected monitor. In this way, boroscopic testing supplies images of places that would never have been accessible without removing major components.

An aircraft engine has, for boroscopic investigation, a plurality of special apertures allowing the optical unit to be guided directly to the point to be tested, for example into any individual compressor stage. A single aperture is sufficient for the latter, since the blades to be tested can be rotated manually in front of the optical unit of the boroscope. Rigid components without direct access are inspected using a flexoscope. Instead of the rigid tube, this tool has a flexible hose in which glass fibers replace the optical lens. With a working length of several meters, it can also be used to inspect components not reachable in a straight line.

FIG. 3 schematically shows a partial axial sectional view through a gas-turbine engine with principal accessibilities for boroscope work. As can be seen here, access to a very wide range of areas of the gas-turbine engine is possible by the removal of attachments, by opening of access apertures and similar.

FIG. 3 especially shows the following components/parts:
A High-pressure compressor rotor blades, stage 1, leading edge
B High-pressure compressor rotor blades, stage 1, trailing edge
High-pressure compressor rotor blades, stage 2, leading edge
C High-pressure compressor rotor blades, stage 3, trailing edge
High-pressure compressor rotor blades, stage 4, leading edge
D High-pressure compressor rotor blades, stage 5, trailing edge
High-pressure compressor rotor blades, stage 6, leading edge
E High-pressure compressor rotor blades, stage 9, trailing edge
High-pressure compressor rotor blades, stage 10, leading edge
F High-pressure turbine rotor blades, stage 1, leading edge
High-pressure turbine stator vanes, stage 1, combustion chamber
G High-pressure turbine rotor blades, stage 1, trailing edge
High-pressure turbine rotor blades, stage 2, leading edge
H High-pressure turbine rotor blades, stage 2, trailing edge
I Low-pressure turbine rotor blades, stage 1, leading edge

Low-pressure turbine rotor blades, stage 2, trailing edge.

FIG. 4 shows schematically the use of boroscope equipment in combination with the method in accordance with the invention. Here a part of a casing 4 is shown which is provided with a boroscope aperture 5 (access aperture). This can be provided by removal of a cover or by removal of a unit or similar. A manipulator 6 is introduced through the aperture 5. The manipulator 6 is connected to a control unit 7 which can for example be connected to a hose 8 through which media can be supplied or extracted. In the schematic exemplary embodiment shown in FIG. 4, the control unit 7 has a monitor 9.

The manipulator 6 can be linked to a tool for removing and extracting/analysing particles. A display and actuation unit or the control unit 7 permits checking and controlling of the work by means of the monitor 9.

It is understood that the representation in FIG. 4 shows the individual components and their mode of operation only in a very schematic form.

The invention makes it possible to perform cleaning of the cooling-air holes without removing the engine from the aircraft. To do so, miniaturized tools are supplied to the repair/cleaning area via boroscope apertures located on the engine. It is possible with the aid of the boroscope to remove particles from contamination using a tool and to collect them in combination with a local extraction device. An analysis of the contamination particles permits differentiated selection of an appropriate cleaning medium. With the aid of the boroscope, the suitable cleaning medium (pasty form or snow blasting or dry ice blasting) is applied to the affected area of the high-pressure turbine stator vane or rotor blade. By specific selection of the cleaning medium, initial dissolving of the contamination or a neutralization of the adhesive mechanism between component and contamination particles is achieved. By mechanical reworking, e.g. by a micro-blasting medium supplied with the aid of the boroscope in combination with an effective extraction device, the component surface or the cooling-air hole is cleaned. Alternatively to mechanical reworking, it is also possible to use a cleaning fluid adapted to the selected cleaning medium. With the aid of the boroscope, this fluid can be targeted at the area to be cleaned. Using an extraction device, a major part of the dissolved contamination particles together with the cleaning fluid are extracted. A concluding visual check ensures that the area to be cleaned is again largely adapted to drawing requirements and hence restored to a proper state.

FIG. 5 shows an exemplary embodiment of a device 10 in accordance with the invention with an insert aid 11 and a tool head 12. The insert aid 11 has a flange 13 which can be bolted to the casing 4.

FIG. 6 shows in detail the device in accordance with the invention. Here a jet nozzle 14 and an optical unit 15 for monitoring the treatment of the cooling-air holes 3 of the stator vanes 1 can be seen in the tool head 12. Furthermore, the shape memory wires 16, control lines 17 for resistor heating, a medium hose 18 for the treatment fluid and a glass fiber 19 for the optical unit plus an inner supporting hose 20 can be seen.

FIG. 6 thus shows the actuating device formed by the shape memory wires 16. They allow, as shown in FIG. 6, movement or angled approach by the front area of the treatment device 10. This enables the distal end of the treatment device 10, in particular the jet nozzle 14, to be exactly placed for cleaning the recesses of the turbine blades. Since the geometry of the respective aircraft gas-turbine engine to be treated is predetermined and already known, it is possible to dimension and position the device in accordance with the invention exactly such that an exact and accurate treatment/cleaning of the cooling-air outlet openings of the turbine blades is possible. The exact placement is achieved in particular in that the flange 13 can be fastened/bolted in the area of the access apertures/boroscope apertures or in the area of the removed fuel injection nozzles of the combustion chamber 21. When the shape memory wires are activated, the jet nozzle 14 thus reaches the specified place for its use. It is also possible in accordance with the invention to provide several such shape memory wires, to optionally allow different treatment positions to be reached.

FIG. 7 shows a view of a combustion chamber 21 with emplaced insert aid 11 and treatment device 10. In particular the fastening of the flange 13 (FIG. 6) to the mounting points of the fuel injection nozzles is shown here.

FIG. 8 shows the treatment device 10 in non-active and straight form, inserted in the combustion chamber 21, while FIG. 9 shows the treatment device 10 actively deflected, said deflection, as explained above, being achieved by activation of the shape memory elements.

FIG. 10 shows a further exemplary embodiment of the treatment device in accordance with the invention. The upper portion of FIG. 10 shows a non-inflated rail 22 which is inserted into an engine. FIG. 10, lower portion, shows this rail 22 inflated and with an inserted supply line for a treatment tool 10. The rail 22 here takes on a predetermined volume and in so doing braces against the inner walls of the combustion chamber 21, thus generating a stiffness sufficient for the treatment.

FIG. 11 shows schematically a further exemplary embodiment of the treatment device in accordance with the invention. It includes a cable pull system. Here a treatment device 10, over which is cable 24 is passed, is fastened to the boroscope aperture 5 or to the engine outlet 23. The cable 24 must be inserted into the engine before the treatment. The treatment tool 10 is attached to the cable 24 and can be moved along the high-pressure turbine inlet stator vanes 1b by pulling on one of the cable ends so that these vanes can be treated.

The invention makes it possible to perform the clearing of the cooling-air holes without removing the engine from the aircraft. To do so, miniaturized tools are moved to the repair/treatment area via the boroscope apertures located on the engine. A concluding visual inspection ensures that the area to be treated is again adjusted largely to comply with drawing requirements and hence restored to its proper state.

### LIST OF REFERENCE NUMERALS

1a High-pressure turbine rotor blade/rotor blade
1b High-pressure turbine stator vane/stator vane
2 Deposits/layers of dirt/foreign matter coatings
3 Cooling-air recesses (cooling-air holes)
4 Casing
5 Access aperture/boroscope aperture
6 Manipulator
7 Control unit
8 Hose
9 Monitor
10 Treatment device
11 Insert aid (tube)
12 Tool head with tool
13 Flange
14 Jet nozzle
15 Lens for glass fiber optics/optical unit
16 Shape memory wire
17 Control line for resistor heating
18 Medium hose
19 Glass fiber/glass fiber optics/optical monitoring element
20 Inner supporting hose
21 Combustion chamber
22 Inflatable rail/rail element
23 Engine outlet
24 Cable

1. Treatment device for in-situ treatment of turbine blades/vanes of a gas turbine, with the treatment device being insertable into a combustion chamber of the gas turbine via at least one access aperture and placeable on cooling-air recesses of the turbine blades, with the treatment device at its end including a tool head with at least one tool and at least one jet nozzle, with the jet nozzle being connected to a medium hose for externally supplying a treatment fluid, with the treatment device being provided with an actuating device for exactly guiding and/or placing and/or moving the tool head.

2. Device in accordance with claim 1, characterized in that the actuating device includes elements made from a memory alloy.

3. Device in accordance with claim 2, characterized in that the actuating device includes a heating device for the elements made from a memory alloy.

4. Device in accordance with claim 1, characterized in that the actuating device includes a cable pull system with at least one cable.

5. Device in accordance with claim 1, characterized in that the actuating device includes at least one inflatable, balloon-type rail element.

6. Device in accordance with claim 1, characterized in that the device includes an optical monitoring element with at least one glass fiber optics.

7. Method for treatment of high-pressure turbine blades/vanes of a gas turbine using a device in accordance with claim 1, where deposits and/or foreign matter coatings in the area of cooling-air recesses are removed, with particles of the deposits and/or the foreign matter coatings being removed and extracted in the non-removed state of the gas turbine using a tool.

8. Method in accordance with claim 7, characterized in that the deposits and/or the foreign matter coatings are removed by blasting using a compressed fluid jet.

9. Method in accordance with claim 8, characterized in that the fluid used is water, water with additives, oil, carbon dioxide or nitrogen.

10. Method in accordance with claim 7, characterized in that high-energy light (laser) is used for removing the foreign matter coatings.

11. Method in accordance with Claimj 7, characterized in that after removal of deposits and/or foreign matter coatings these are rinsed out by means of a gas.

12. Method in accordance with claim 7, characterized in that the method is conducted under visual control.

13. Method in accordance with claim 7, characterized in that the tools and/or equipment needed to perform the method are inserted into the area of the high-pressure turbine through boroscope apertures provided in the gas turbine or through apertures created by the removal of components.

14. Method in accordance with claim 7, characterized in that the guiding of the tool and/or equipment is achieved by a treatment device having the capability to change its shape due to the use of shape memory wires.

15. Method in accordance with claim 7, characterized in that the guiding of the treatment tool and/or equipment is achieved using rigid, flexible or volume-increasing rails or cables.
